(19) United States
(12) Patent Application Publication
(10) Pub. No.: US 2007/0166498 A1
(43) Pub. Date: Jul. 19, 2007

(54) Carpentry shimming system

(76) Inventor: Christopher Joseph Penar, South Lyon, MI (US)

Correspondence Address: JOHN L CHIATALS, 50325 ANN ARBOR RD., PLYMOUTH, MI, 48170, US

(21) Appl. No.: 11/332,110

(22) Filed: Jan. 13, 2006

(51) Int. Cl. B32B 33/00

(52) U.S. Cl. 428/40.1

(57) ABSTRACT

According to the present invention, an assembly for shimming a construction member to an opening is provided. The assembly includes a plurality of stacked leaves made primarily of cellulosic material. The leaves have a shape with a uniform thickness, defining a pad presenting front and back surfaces. A strip is located on either or both of the front and back surfaces, the strip being releasable to expose an adhesive for attaching the pad to the construction member. The leaves are secured together by a binding to allow a selected number of the leaves may be manually peeled off the pad to shim the construction member within the opening. The present invention also provides an installation method for a door or window frame, which is fast and accurate especially for a prefabricated door or window unit. Another use is with cabinetry where limited access is possible on the back surface against a finished wall.

### TECHNICAL FIELD

This invention generally relates to the mounting of panels such as door or window units in the rough framed opening of a building being constructed or remodeled. More particularly, the invention relates to a shim device for accurately positioning a unit such as a door or window in the rough framing formed prior to nailing or otherwise fastening the unit in place.

### BACKGROUND

In new construction and also in remodeling, doors are typically provided along with a frame assembly for installation in a doorway. The complete door frame, which typically consists of two side jambs (a hinge jamb and a strike jamb) and a head jamb, are nailed to wall studs to form a frame around three sides of the door. The head jamb spans the distance between the side jambs at their tops. Casing members are placed around the perimeter of the doorway. The rough opening is intentionally made larger than a window or door unit and it is anticipated that stacked shims be inserted in the peripheral space around the unit to maintain the unit level in the desired location within the opening.

Numerous problems must often be overcome before the jambs and the door may be installed. The doorway studs may be twisted or warped. The jambs may also be warped or not uniform. The jambs may have a camber from production at the factory.

If these problems are not corrected then the door frame may not be plumb and the reveal (the space between the door and the jambs) may not be uniform. The door may then not open and close properly. The strike jamb may rub against the door when closed. There may further be tension between the door and the hinge jamb. The door may rub against the floor or head jamb, the door may tend to swing in an open or closed direction by itself.

Various devices and methods have attempted to overcome these problems to ensure that the jambs are plumb and the reveal is uniform. To properly align the window or door, wedges are conventionally tapped between the doorjamb or window jamb and the wall's structural members to force the door or window jamb into a desired position. Typically, an installer will insert tapered wedges between the jambs and the studs in an attempt to adjust the reveal and square the jambs. This is time-consuming and may not be effective for severe warping. One type is a pre-manufactured shim with a general size on the order of nine inches long by a couple of inches wide, and made of varying thickness (generally from a very small part of an inch up to perhaps one-half inch thick, in a wedge shape. The shim is inserted until the desired thickness exists for the application. Any unneeded part of the shim extending or protruding from the frame is broken off or sawed off. This type of shim avoids having to try different scraps of wood, alone or in combination, to find a fit. Tapered shims do not provide a constant spacing thickness and thus lack uniform continuous support between the abutting elements of a construction element and supporting member. Wedges must be abutted together to approximate a constant thickness in the space they take up between shimmed surfaces; however, in many cases this principle cannot be used, e.g., where shimming cabinetry, since access cannot be gained from opposite sides of a wall. The same is true where a finished wall is the abutting surface surrounding a door opening.

Mounting requires careful adaptation and much manipulation if the fasteners are to exert required holding force without deformation and bending of the door frame. Even a skilled carpenter requires a fair amount of time to install a door frame in a rough opening, due to the necessity of locating and placing the shims to accommodate plumbing the door frame. Often, scraps of wood, or shingles are used for this purpose. However, it is often tedious and difficult to find a shim piece of the desired size and shape to achieve the correct spacing. Some carpenters whittle shims from construction scrap or any bits or pieces of wood found on the building site, or modify existing shim stock to fit their present need.

Typically, shims can be made and sold with different thicknesses so that they can be stacked to produce any thickness divisible by the thinnest shim. The shims are stacked so that their lengths are aligned in parallel.

The stacked shims are often difficult to group and maintain in proper orientation, particularly when their number exceeds two. Skewing of the shims may result in less than complete overlap over the width of the shim(s) and/or undesired lengthwise projection of one or more of the shims from the other shims in a stack. This may compromise the particular installation, i.e. the placement of the door or window. The combination of different thicknesses stacked to produce the desired overall thickness conventionally requires the user (either a carpenter or homeowner) to hold the accumulated shims in a stack and press the shim stack into place while ideally maintaining the alignment of the individual shims. Any shifting that occurs may result in protrusion of one or more of the shims in a lengthwise direction or lateral offsetting of the shims so that the overlapping width of all shims is diminished, thereby reducing the stability of the stack.

Even if the installer is able to manipulate the multiple shims and maintain their alignment, it is inconvenient to have to press fit them as a group. Repeated attempts may be necessary to properly install the shims.

It has been proposed that multiple frictionally held shims of a U- or horseshoe-shaped body can be stacked in any number using a combination of any thickness to produce a desired stack thickness. The entire stack can be maintained in an operative position facilitating its assembly and placement.

Typically, shims are made with different thicknesses so that they can be stacked to produce any thickness divisible by the thinnest shim. The shims are stacked so that their lengths are aligned in parallel.

Even if the installer is able to manipulate the multiple shims and maintain their alignment, it is inconvenient to have to press fit them as a group. Repeated attempts may be necessary to properly install the shims.

During installation, the door or window frame is held plumb and stationary prior to nailing with use of spacers or wedges (shims) placed between the rough framed opening and the prefabricated door or window frame. The shims adjust the jamb to plumb positions. Thus, by a manual positioning of various wedge combinations, the frame can be eventually positioned and nailed in place.

The use of wood for shims is part familiarity, part flexibility and part availability. Wood has long been the material of choice in many construction projects, particularly residential. Scraps are always available. Historically wood has been relatively inexpensive. Also, of course, wood is relatively easy to work—to form, to adjust in size, compressible and easy to handle. However, conventional wood shims have certain deficiencies that provide room for improvement in the art. First, wood pieces of this size can split or splinter relatively easily, especially if forced into position and/or struck with a hammer or tool. Splitting or splintering can defeat the purpose of the shim and can cause safety problems. Although relatively easy to handle and alter in size, shims may require tools and substantial handling which is time-consuming.

It has also been discovered that room for improvement exists with respect to the manufacturing and packaging of shims. Wood shims are independent pieces that must be collected then either sold individually or in a package loose. If they are to be positioned in any order to conserve space and/or to provide for more uniform or easier packaging, this requires significant manual labor and/or some sort of binding device such as a rubber band or the like.

Oftentimes shims are nailed into place so as not to fall or slide. This is usually done when an exact location must be maintained. The problem with the wooden shim is that it does not always hold a nail, resulting in a shim that falls or will not maintain a constant location place without splitting or compromising its position.

Conventional shims, typically made of wood wedges or shingles, are inconsistent in size and shape and thus add to the difficulty of properly installing a door or window jamb. More particularly, these wedge shaped shims are imprecise and without a size standard. Therefore, a shim is needed that accurately and reliably adjusts a doorjamb or window jamb within a rough opening in a wall for proper alignment.

### SUMMARY OF INVENTION AND ADVANTAGES

The present invention provides an assembly for shimming a construction element to a construction member or opening. The assembly includes a plurality of stacked leaves made primarily of cellulosic material. The leaves have a shape with a uniform thickness, defining a pad presenting front and back surfaces. A strip is located on either or both of the front and back surfaces, the strip being releasable to expose an adhesive for attaching the pad to the construction member or opening. The leaves are secured together wherein a selected number of the leaves may be manually peeled off the pad to shim the construction member within the opening.

An inventive process is provided for installing generally a construction element, e.g., a door, window or cabinet, generally to a construction member, e.g., a stud or wall, or to a construction opening, e.g., a rough door or rough window opening, using the pad assembly of the present invention. In the preferred aspect of a door installation, prior to the door being placed in the rough opening, a plurality of the pads is stuck to the hinge stud at vertically spaced locations. The pads are peeled until all the resultant blocks of the pads are plumb using carpenter's level, ensuring that the hinge stud of the rough opening against which the hinge jamb is fastened, is therefore plumb. Likewise a plurality of the pads is placed under the door to level the bottom of a rough opening using e.g., a carpenter's level and also to raise the door for future flooring to be installed. An alternative embodiment is for interior doors wherein pads under the floor jamb are not stuck to the sub-flooring or to the floor jamb but rather are set temporarily and then removed after the door is secured. However, in an alternative embodiment for exterior entry installations the pads are stuck under a floor jamb and left in place. The door frame is inserted into the rough opening and the hinge jamb secured preferably through the hinges to the hinge stud. Partial pads are peeled and test fit between the strike jamb and strike stud until the strike jamb is plumb as determined, e.g., by a carpenter's level; then once the strike jamb is properly spaced from the strike stud, the strike jamb is fastened to the strike stud. Preferred methods are also disclosed for window and cabinetry installations, using the pads of the invention.

An advantage of the present invention is that the pads do not spin while a door frame is being screwed through the pads to the studs of a rough opening, nor do the pads split when fasteners are driven or hammered through the pads, because their binding holds the leaves together and adhesive holds the pads to the studs.

Another advantage of the present invention is increased speed and accuracy of installation by a skilled carpenter, also by less experienced persons who may properly install a door or window frame. Cabinetry or other panels may be fastened even while only a single access point is available, such as on the backside against a wall.

A further advantage is a shim assembly that is flexible in application and use, adjustable in size and economical to manufacture so that multiple shimming assemblies can be linked together for easy manipulation into a compact, symmetrical shape that has improved packaging and marketing characteristics.

Other objects and advantages will become apparent to a reader skilled in the art, with reference to the following Figures and accompanying Detailed Description wherein textual reference characters correspond to those denoted on the Drawings.

### BRIEF DESCRIPTION OF THE DRAWINGS

In the accompanying drawings:

FIG. 1 is a perspective view of a shimming assembly, according to the present invention;

FIG. 2 is a perspective view of a shimming assembly similar to FIG. 1, having thinner leaves;

FIG. 3 is a perspective view of a shimming assembly similar to FIG. 1, having a mixture of thinner and thicker stacked leaves;

FIG. 4 is a perspective view of a shimming assembly similar to FIG. 1, having thicker stacked leaves;

FIG. 5 is a perspective view of a door frame with pre-hung door, shown prior to plumbing and shimming within the rough opening, according to the present invention;

FIG. 6 is a sequential view of FIG. 5, showing the door shimmed and leveled in the opening;

FIG. 7 is a perspective view of a window frame and pre-hung window shown prior to plumbing and shimming within a rough opening, according to the present invention;

FIG. 8 is a sequential view of FIG. 7, showing the window frame fitted in place;

FIG. 9 is a perspective view of a countertop shown plumbed and leveled by shimming to a wall surface, according to the present invention;

FIG. 10 is a perspective view showing the bottom of a cabinet being plumbed and leveled by shimming with assemblies of the present invention;

FIG. 11 is a perspective view of a rough door opening having shimming assemblies of the present invention further adhered to the door stud on the locking side of the door jamb with leaves from the Applicant's assemblies torn off as needed until being used to (inset) and the same being plumbed;

FIG. 12 is a sequential view of FIG. 11, showing the door shimmed in the rough opening with a peeled-off section of the pad used to shim the jamb opposite the hinge jamb;

FIG. 13 is a perspective view of a set of shimming assemblies of the present invention packaged for sale as a kit in various construction uses;

FIG. 14 is a perspective view of a pre-hung door having the shimming assemblies of FIG. 13 packaged and attached for use in installing the door as in FIGS. 5-6;

FIG. 15 is a perspective view of a pre-hung window having the shimming assemblies of FIG. 13 packaged for use in installing the window as in FIGS. 7-8; and

FIG. 16 is a perspective view of a cabinet having shimming assemblies of FIG. 13 packaged for use in installing the cabinet as in FIGS. 9-10.

### DETAILED DESCRIPTION

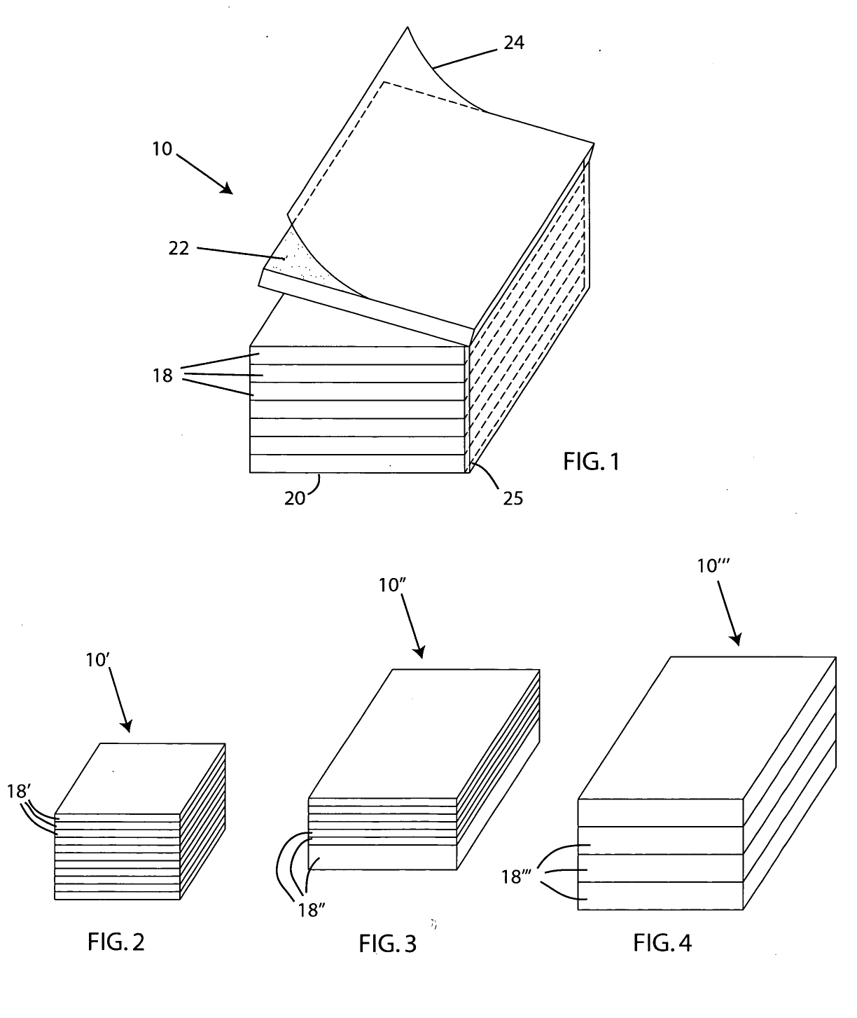

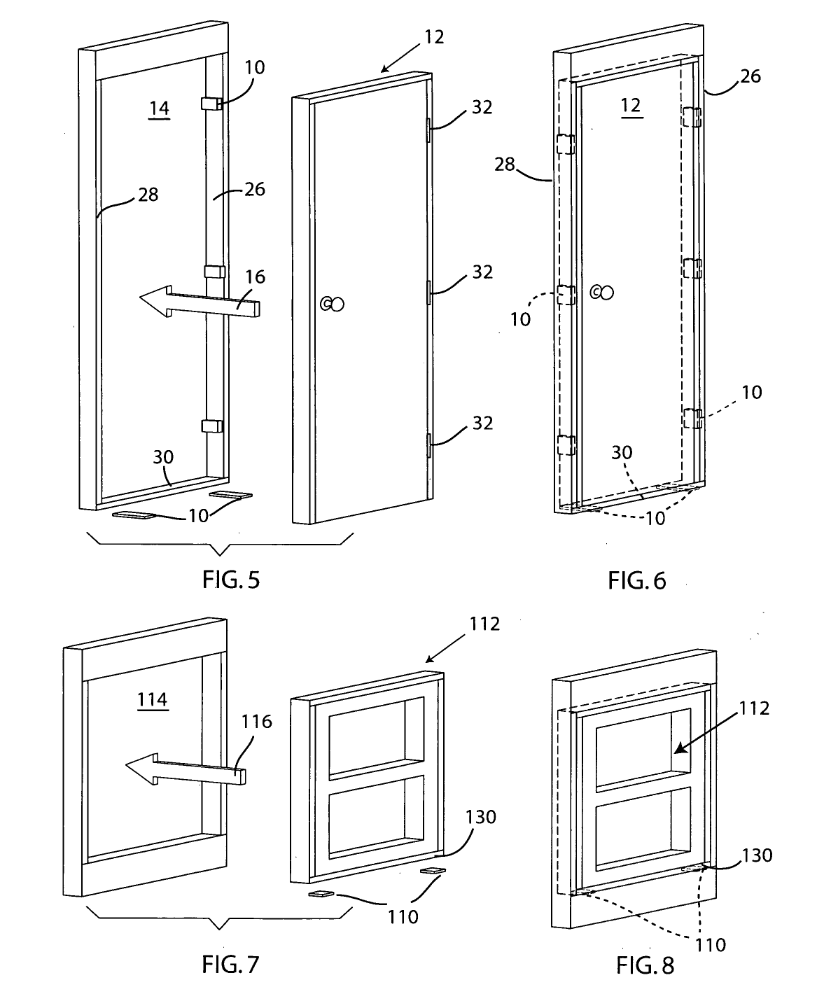

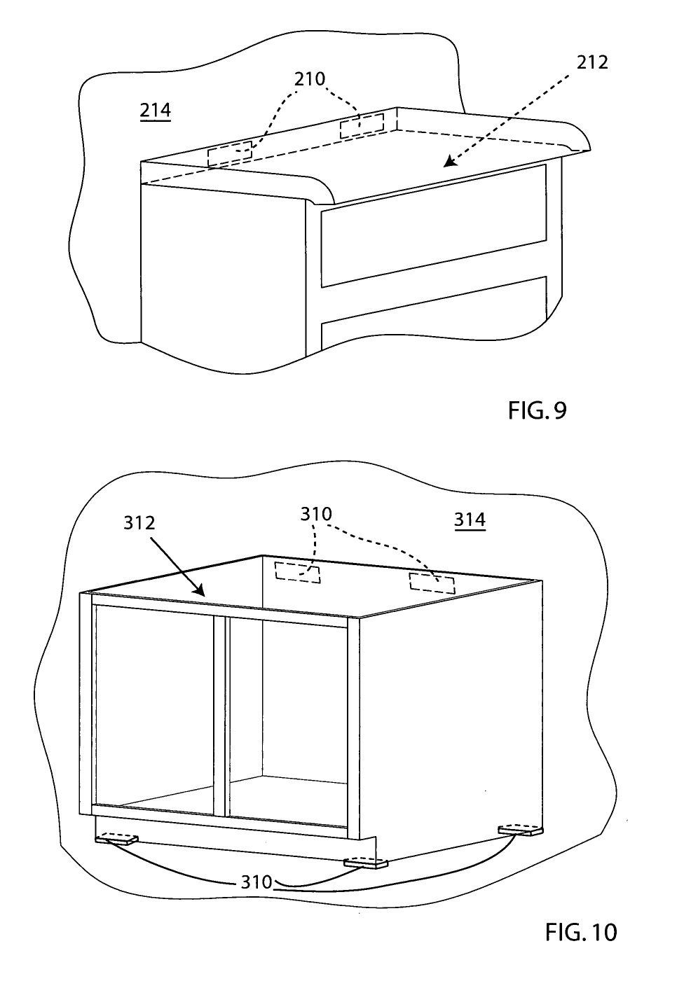

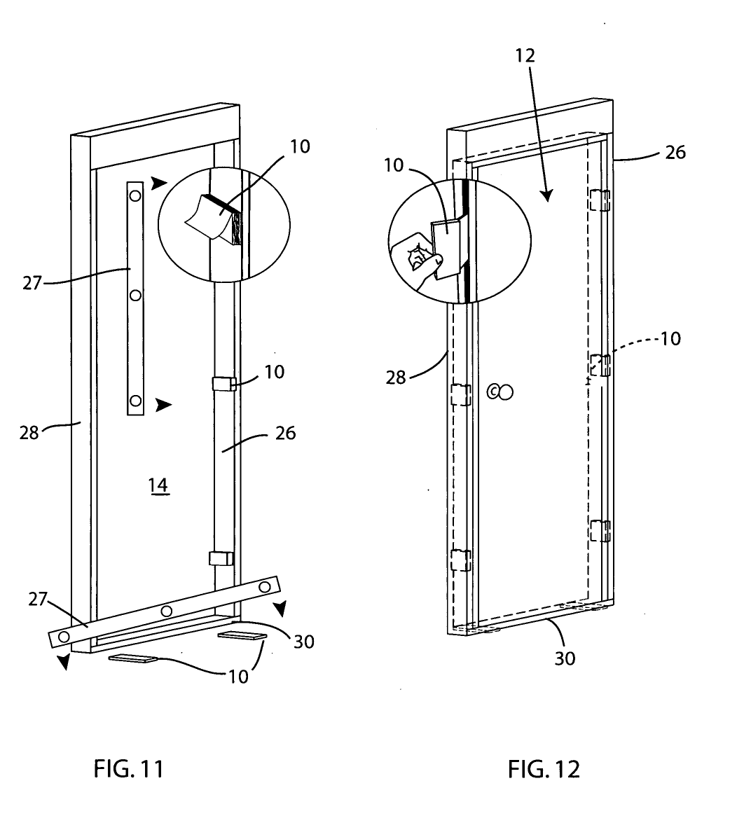

Reference is made to FIGS. 1-16 where an assembly in the form of a pad 10, 110, 210, 310 is generally depicted according to the present invention. Assembly 10, 110 is particularly useful for shimming a construction member such as a pre-hung door-frame 12 or pre-hung window-frame 112 preferably to a rough door 14 or window 114 opening as indicated by arrows 16, 116 in FIGS. 5 and 7, respectively. Assembly 210 is particularly useful in shimming a countertop 212 as shown in FIG. 9 or in a related manner, to shim a cabinet 312 as shown in FIG. 9. Assembly 10, as with assemblies 110, 210, 310, may take a number of alternative forms as will be explained further with reference to FIGS. 2, 3 and 3. Referring to FIG. 1, assembly 10 includes a plurality of stacked leaves 18 made primarily of cellulosic material. Leaves 18 have a similar common shape and each has a constant thickness. Alternatively, with respect to FIG. 2, leaves 18′ of pad 10′ can have a lesser common thickness than that shown in FIG. 1 or as shown in pad 10′″ of FIG. 4 leaves 18′″ can have a greater common thickness than that shown in pad 10 of FIG. 1. A further alternative is shown in FIG. 3 wherein leaves 18″ of pad 10″ can have variable thicknesses rather than a common thickness as in pad 10 of FIG. 1. In FIG. 1, stacked leaves 18 define pad assembly 10, 110, 210, 310, which in turn presents front 20, 120, 220, 320 and back 22, 122, 222, 322 surfaces. Many common shapes are further possible for leaves 18, with a rectangular shape being shown as representative for each embodiment of assembly 10, 110, 210 and 310 of FIGS. 1-16. Referring to FIG. 1, a strip 24 is located preferably on either one or can alternatively be located on both of the front 20 and back 22 surfaces of pad 10. The surface 20, 22 opposite strip 24 may be printed with use instructions. Strip 24 is releasable to expose a pressure sensitive adhesive layer (not shown) for attaching the pad assembly 10, for example, to hinge stud 26 as shown in FIG. 5 and to the opposite or strike stud 28 as shown in FIG. 6 to level the door frame 12 prior to installation. Means are provided in the form of a binding 25 for commonly securing leaves 18 together as shown in FIG. 1; for example, the binding could be a relatively inexpensive hot-melt adhesive of the type known in the art. As a result, a selected number of leaves 18 may be manually peeled off pad 10 to shim door 12 within rough door opening 14 as shown further in FIGS. 11-12. Likewise, a selected number of leaves 18 may be peeled off the pads 10 placed under the floor jamb 30 to raise and level door 12 as desired.

To simplify installation of door 12 or window 112 (FIGS. 5-6 and 11-12 or 7-8), it is desirable to use the least number of leaves 18 of the type shown in FIG. 1. It is common to construct leaves 18 or alternatively leaves 18′, 18″, 18′″ of FIGS. 2-4 with a thickness of as much as ¼ inch for this purpose. However, because the space to be filled by the leaves 18, 18′, 18″, 18′″ can vary considerably, and the space may not be divisible by even increments of ¼ inch, different thicknesses of the leaves could be provided as alluded to in the discussion of FIGS. 2-4. For example ⅛-inch, 1/16-inch and preferably 1/32-inch thicknesses could be employed. Stock material originating from wet processed cellulose fiber based virgin kraft and/or waste sources, could be used. Waste stock that is used with print then cleaned and recycled could be used. A mixture comprising natural fibers and plastic or silicone material could be used. Alternative preferred materials could be used where more waterproof characteristics are needed; such is in external entry applications. Such a preferred material is a 0.022″ thick, i.e., 22-point solid unbleached sulfate board (chipboard) also stock known by the generic term “linerboard” available from any number of packaging manufacturers. A size of pad 10 found to be useful is approximately ½ representing each shimming location during installation. Generally, a ⅜″ reveal is expected surrounding the door frame. So-called linerboard is known for use in the beverage industry where the bottoms of beverage cases may need to resist moisture and spillage. Using a stock that carpenters can write upon is an advantage. Using a stock that is more waterproof, for external entry doors under the floor jamb, is advantageous where the pad will remain installed with the door. Plastic or laminate material sold under the trade name “Formica” is generally too incompressible and/or expensive thus undesirable for the uses contemplated herein.

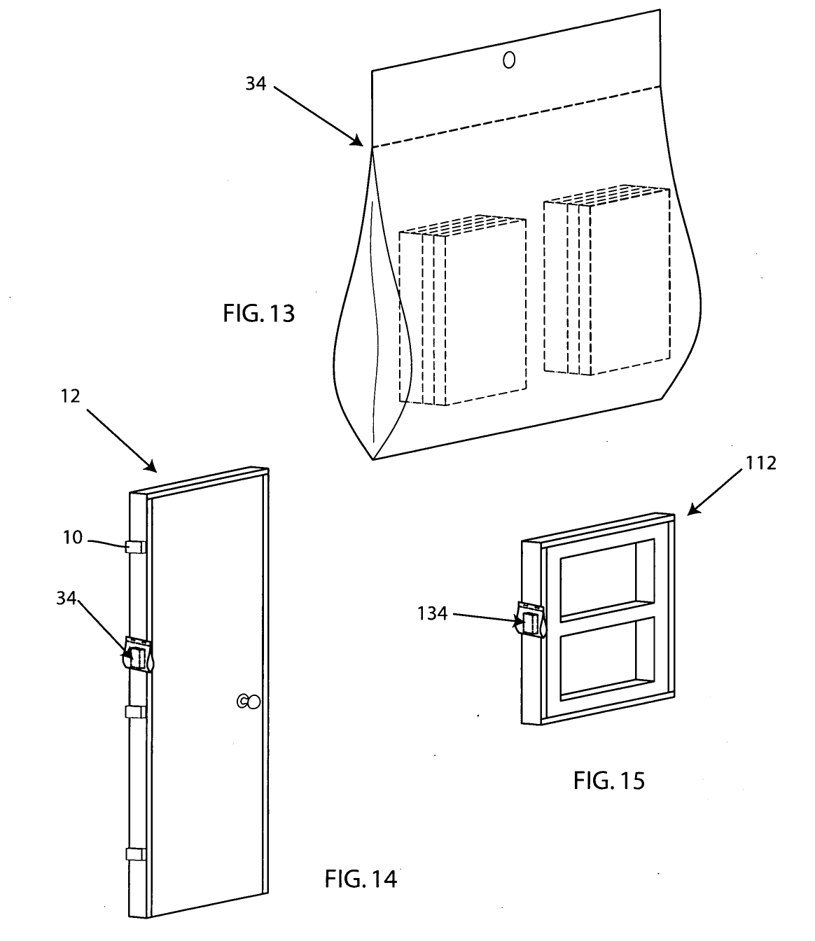

According to the present invention, there is provided a method of installing a construction element such as a door 12, window 112, countertop 212 or cabinet 312 onto a construction member such as a wall stud 26, 28 or within an opening 14, 114 defined by such member. The inventive process includes the following steps, which may be performed in the order given or in any reasonable modification that leads to a similarly beneficial result. By way of example, a preferred process for installing a pre-hung door will be used to illustrate practice of the inventive method, as shown in FIGS. 1, 5-6 and 11-12. Prior to the door being placed in the rough opening 12, a plurality of pads 10 is stuck to the hinge stud 26 at vertically spaced locations. The pads are peeled (see FIG. 11 inset) until all the resultant blocks of the pads are plumb using carpenter's level 27 (arrows), ensuring that the hinge stud 26 of the rough opening is therefore plumb. Likewise a plurality of the pads 10 is placed under floor jamb 30 to level the bottom of rough opening 14 using level 27 and to raise the floor jamb for future flooring to be installed. For interior doors pads 10 under floor jamb 30 are not stuck to the sub-flooring or to the floor jamb but rather are set temporarily and then removed after the door 12 is secured. However, for exterior entry installations the pads are stuck and left in place. The door 12 is inserted into the rough opening 14 and secured at and preferably through the hinges 32 to the hinge stud 26. Partial pads 10 are test fit (see FIG. 12 inset) and placed between the jamb 12 and the strike stud 28 (FIG. 6) then the jamb and strike stud are fastened together preferably through the pads. Pads 10 do not spin while door 12 is being screwed to studs 26, 28 of opening 14, nor do the pads split when fasteners are driven or hammered through the pads, because binding 25 holds leaves 18 together and adhesive holds the pads to the studs. In FIGS. 7-8, the process is similar for a pre-hung window 112, insofar as pads 110 are placed under the sill jamb 130 to level the window in a rough opening 114 that is plumbed. Likewise, in FIG. 10, pads 310 are placed under the cabinet 312 to level it and also pads are stuck on the walls in back of the cabinet to plumb the cabinet. A floor-mounted cabinet 312 is used for illustration purposes however an upper-hung installation would likewise benefit from the inventive method. The countertop 212 of FIG. 9 is plumbed using pads 210 as shown. In conjunction with the standing cabinet 312, the inventive method can thus be used to install the full range of kitchen cabinetry to a wall 214, 314, without the need to cut-off protruding portions as is the case with prior art wedge shims. As shown in FIGS. 13-16, pads 10, 110, 310 can be pre-packaged in plastic bags 34, 134, 334 that are provided as kits attached to the door 12, window 112 or cabinet 312 for convenient installation use. Pads 10 may be stuck on the door 12 as sold, then unstuck and later used. Adhesive layers can be provided in several places on the pad 10, 110, 210, 310 (not shown) for this purpose.

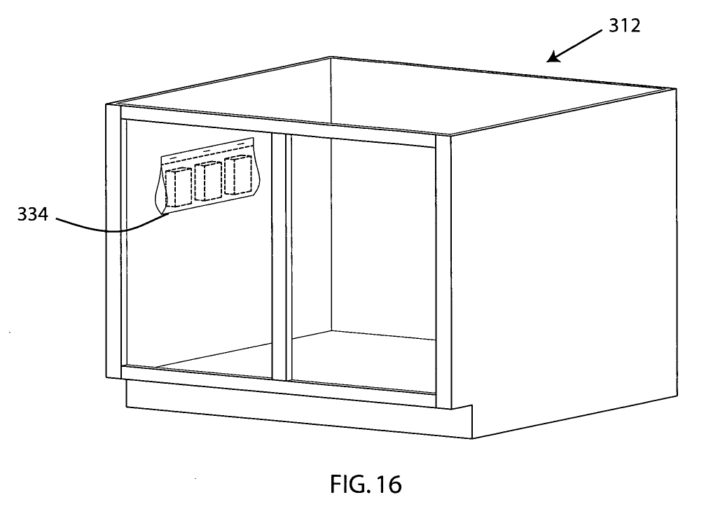

Referring to FIG. 16, cabinetry 312 often must be installed where the carpenter cannot access the shimming site from more than a single approach. The wall-side of the cabinet can have pads 310 peeled as appropriate then stuck thereon to space/shim the cabinet to the wall 314. For this reason, prior art wedges are a problem to use for shimming.

The present invention is by no means restricted to the above described preferred embodiments, but covers all variations that might be implemented by using equivalent functional elements or devices that would be apparent to a person skilled in the art, or modifications that fall within the spirit and scope of the appended claims.

1. A carpentry shimming assembly for installing a construction element to a construction member or opening, the assembly comprising:
a plurality of stacked leaves made primarily of cellulosic material of uniform shape and thickness, defining a pad presenting front and back surfaces;
a strip located on either of the front and back surfaces, the strip being releasable to expose an adhesive for attaching the pad to a construction member; and
means for securing the leaves together wherein a selected number of the leaves may be manually peeled off the pad to shim the construction element within a construction opening or to a construction member.

2. The assembly of claim 1 wherein the pad has a block thickness from approximately 0.25 to 1.0 inches and wherein the individual leaves each has a thickness from 0.004 inches to 0.25 inches.

3. The assembly of claim 1 wherein the leaves are made of chipboard and have a thickness from 0.020 inches to 0.030 inches.

4. The assembly of claim 1 wherein the construction element is a pre-hung door or window that is installed in a construction opening.

5. The assembly of claim 1 wherein the means for securing the leaves together further comprises a binding.

6. The assembly of claim 5 wherein binding further comprises a hot-melt adhesive.

7. The assembly of claim 5 wherein the construction element is a cabinet that is installed against a wall.

8. A carpentry shimming assembly for installing a door or window to a rough opening, the assembly comprising:
a plurality of stacked leaves made primarily of cellulosic material of uniform shape and thickness, defining a pad presenting front and back surfaces;
a strip located on either of the front and back surfaces, the strip being releasable to expose an adhesive layer for attaching the pad to a stud; and
a binding joining a common edge of the leaves securely together wherein a selected number of the leaves may be manually peeled off the pad to shim the door or window within the construction opening.

9. A process for installing a construction element to a construction member or opening, comprising the steps of:
providing a suitable complement of the pads as set forth in claim 1;
adhering a plurality of the pads to a vertically oriented construction member, at spaced apart locations.
peeling off leaves from the pads until resultant blocks of the pads are relatively plumb, making the vertically oriented member therefore plumb;
placing another plurality of the pads on a horizontally oriented construction member to level and to raise the construction element to a desired position; and
securing the element to one or more of the members.

10. The process of claim 9 further comprising the step of providing a construction element that is a door or window and providing a plurality of studs defining the construction opening.

11. The process of claim 10 wherein the construction element provided is a cabinet or countertop and a plurality of the construction members define a wall.

12. A carpentry shimming assembly for installing a construction element to a construction member or opening, the assembly comprising:
a plurality of stacked leaves of uniform shape and thickness, presenting a common border;
means for flexibly and removably attaching the leaves together along the common border to define a pad, wherein a selected number of the leaves may be manually peeled away from the pad for the pad to shim the construction element to the construction member or within the construction opening.

13. The assembly of claim 12 wherein the means further comprises a binding that extends along and joins a common edge of the borders.

14. The assembly of claim 12 wherein the binding further comprises an adhesive member.

15. The assembly of claim 12 wherein the pad delimits front and back surfaces, with a strip located on either of the front and back surfaces, the strip being releasable to expose a tacky adhesive for applying the pad to the construction element or opening.

16. The assembly of claim 12 wherein the leaves further comprise a cellulosic material.

17. The assembly of claim 12 wherein the leaves further comprise a polymeric material.

18. The assembly of claim 12 wherein the pad has a block thickness from approximately 0.25 to 1.0 inches.

19. The assembly of claim 12 wherein individual ones of the leaves have a thickness from approximately 0.04 to 0.10 inches.

20. The assembly of claim 12 wherein individual ones of the leaves are between 22-point and 30-point in weight.

21. The assembly of claim 12 wherein the construction element is a door or window that is installed in a construction opening defined by a plurality of studs.

22. A process for installing a construction element within a construction opening defined by one or more construction members, comprising the steps of:
providing a suitable complement of the pads as set forth in claim 12;
affixing a plurality of the pads to a vertically oriented construction member, at spaced apart locations;
peeling off leaves from the pads until resultant blocks of the pads are relatively plumb, making the vertically oriented member therefore plumb;
placing another plurality of the pads on a horizontally oriented construction member to level and to raise the construction element to a desired position; and
securing the element to one or more of the members.

23. The process of claim 22 further comprising the step of adhering a plurality of the pads to a vertically oriented construction member, at spaced apart locations.

24. The process of claim 22 wherein the construction element being installed is a door or window panel and wherein the construction opening is defined by a plurality of studs.

25. The process of claim 22 wherein the construction element is defined by a cabinet or countertop and a plurality of the construction members define a wall.
